(19) United States
(12) Patent Application Publication
(10) Pub. No.: US 2017/0006789 A1
(43) Pub. Date: Jan. 12, 2017

(54) Tree Stand Water Level Gauge

(71) Applicant: Felipe Santillan, Corvallis, OR (US)

(72) Inventor: Felipe Santillan, Corvallis, OR (US)

(21) Appl. No.: 14/795,707

(22) Filed: Jul. 9, 2015

(51) Int. Cl. A01G 27/00; G01F 23/64; A47G 33/12

(52) U.S. Cl. CPC A01G 27/008; A47G 33/12; G01F 23/64; A47G 2033/1293

(57) ABSTRACT

A water level gauge that indicates the water level in a tree stand is provided herein. The gauge includes a component that floats on the water within the tree stand, a shaft with indicator markings attached to the float component, a transparent housing through which the shaft passes, an indicator line on the housing that, when compared to the indicator markings on the shaft, indicates the level of the water in the tree stand. An attachment apparatus is also provided that attaches the present invention to the tree stand.

### BACKGROUND OF THE INVENTION

The present invention relates an apparatus for monitoring water level and, more specifically, to an apparatus that allows a user to visually monitor the level of water in a tree stand.

### FIELD OF THE INVENTION

The use of trees for decoration or festivities is common throughout history. It could be said that Christmas trees are the most common tree-related feature within the homes of the general population. Typically, when a Christmas tree is in use, the tree requires stabilization against tipping or falling, as the tree no longer has a root structure to counter any lateral or imbalanced forces imparted upon the center of gravity.

Base-mounted tree stands are known within the art. There are many designs of Christmas tree stands currently on the market. Many Christmas tree stands include a basin, which is adapted to be partially filled with water. The basin receives the lower portion of the trunk of the Christmas tree. Various devices have been provided to hold the Christmas tree in an upright position in the Christmas tree stand, such as elongated screws mounted in the stand, which make contact with the trunk of the Christmas tree around its periphery in an attempt to hold the Christmas tree substantially vertical.

In order to prevent premature drying or death of the tree, water and other nutrients are kept within the basin of the tree stand. The tree bring these nutrients up through the internal vascular system of the tree, known as the xylem. This complex system relies heavily on there being an ever-present source of water encompassing the base of the tree, and it is preferred to disallow any significant water depletion within the stand basin. Before the advent of various water gauges, users commonly dipped fingers into the stand basin in an attempt to estimate water levels. As such, a plurality of gauges have been developed to ensure accurate water levels within the tree stand basin.

There exists many tree stands or devices currently available which monitor water levels within a tree stand. One such device employs a standalone unit, which constantly monitors water levels and adds water when levels become low enough to warrant. Unfortunately, this system can be rather space-consuming and aesthetically unpleasing in an area otherwise reserved for gifts or decorations. Other devices are proprietary to specific stands and cannot be retrofitted to the stands already possessed by a potential user.

The vast majority of current water level gauges rely on electrical currents to operate properly, which may not allow the user to employ various decorations in order to keep an electrical outlet open at all times for the water gauge. Battery operated gauges must have batteries replaced often enough to not incur a gauge failure, further increasing operating costs, and potentially increasing the chances of harmful water depletion.

Buoyancy gauges are known within the art. Buoyancy forces occur when an object of density less than that of another material experiences a force proportional to depth. As this force increases with depth, the deeper face of the less-dense material will feel a stronger force than the upper face, and will effectively float or ride on top of the more-dense material. The amount of force needed to submerge the less-dense material is the same as the mass of the volume of the more-dense material it replaces, minus the weight of the less-dense object.

Many gauges employ this simple buoyancy concept, such as the fuel level sensors within a vehicle. A low-density floater rides on the end of a rod with then allows specific amounts of current to move between two points. As the fuel level drops, the floater drops, and subsequently changes the voltage between the two points. This change in voltage is then converted into visual information for the user to read on the dashboard. An elementary version of this method is used to read water levels within sewers, rivers, and other bodies of liquids by placing a low-density floater at the base of a low-weight, marked rod. The rod assembly is then placed within a containment tube with a visual gauge which is congruent with the marking on the rod. The low-density floater rides on top of the liquid to be measured, and the levels can be known from the contained gauge.

It could be said there lies a need for a tree stand water level gauge which is mechanical in nature and easily modified to be used within any existing tree stand.

The present invention meets these needs by providing the user with an easily-fittable water gauge which uses a buoyancy force, and not electricity, as a means to indicate water levels within various tree stands.

### BRIEF SUMMARY OF THE INVENTION

The present invention provides a water level gauge that indicates the water level in a tree stand even when the water level may or may not be visible to the user. The gauge includes a float component that floats on the water within the tree stand. The float component is connected to a shaft with indicator markings that indicates the water level within the tree stand. The shaft passes through a transparent housing component that keeps the shaft in a relatively vertical orientation and allows the shaft to move up and down as the water level within the tree stand raises or lowers. An indicator line on the housing component is provided that, when compared to the indicator markings on the shaft, indicates the level of the water in the tree stand. An attachment apparatus is also provided that attaches the present invention to the tree stand.

In one embodiment of the present invention, a water level gauge is attached by way of an adhesive to the opening lip of a Christmas tree stand. The shaft and float are placed on the water within the Christmas tree stand and the shaft is passed through the transparent housing. The float on the bottom of the shaft causes the shaft to rise within the transparent housing in proportion to the amount of water within the stand. As the tree absorbs water, the level within the Christmas tree stand drops and the shaft moves downward accordingly. The indicator markings on the shaft provide visual cues to a user as to the remaining water level within the stand. When the user replenishes water within the stand, the float and shaft rise indicating the water level has raised.

In another embodiment of the present invention, the gauge is attached to the opening lip of a Christmas tree stand by way of a mechanical fastener. The gauge operates much in the same way as described in the previous embodiment.

It is important to note that the present invention may be used with any tree stand that holds a tree and water for the tree. The present invention is not limited to use only with Christmas tree stands.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 is a front view of a tree stand water level gauge as according to one embodiment of the present invention;

FIG. 2 is a top view of a tree stand water level gauge as according to one embodiment of the present invention;

FIG. 3 is a view of a tree stand water level gauge showing a high water level as according to one embodiment of the present invention; and

FIG. 4 is a view of a tree stand water level gauge showing a low water level as according to one embodiment of the present invention.

A further understanding of the present invention can be obtained by reference to a preferred embodiment set forth in the accompanying description. Although the illustrated embodiments are merely exemplary of apparatus for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, gauge, and apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and gauges for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a tree stand water level gauge that is used to indicate the level of water within a tree stand. For the purpose of clarity, all like elements mentioned in this description will have the same designations. The terms “tree stand water level gauge”, “water level gauge”, “gauge”, “invention”, and “present invention” may be used interchangeably. Furthermore, the terms “tree stand”, and “stand” may be used interchangeably. In addition to the functions, features, components, and abilities of the invention already discussed in this specification, the invention may also have, but not be limited to, the following features contained within the description below.

The present invention solves the shortcomings of the prior art by providing a tree stand water level gauge used with tree stands to allow users to quickly and easily determine when more water needs to be added to the tree stand. The gauge can be used to determine the level of water within the tree stand when the water level is not easily visible because of the shape of the tree stand, or if the water level is obscured by a tree held within the stand. The preferred embodiments described below set forth the present invention in greater detail.

The term tree stand, as used herein, refers to any stand used to hold trees and water for the trees. Most commonly, the present invention will be used with Christmas tree stands to measure the available water level for the Christmas tree. However, there are many species and types of trees that may be used in a tree stand with the tree stand water level gauge other than Christmas trees.

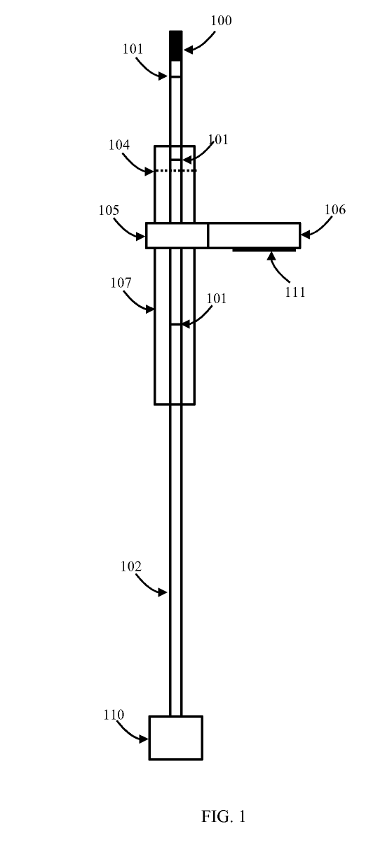

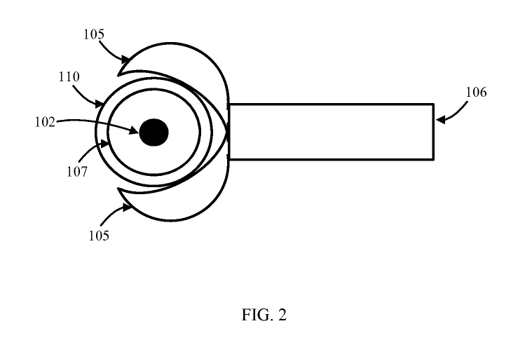

Referring now to FIGS. 1 and 2 that will be discussed together, there are shown views of a tree stand water level gauge as according to embodiments of the present invention.

The tree stand water level gauge generally comprises a float (110) that floats on the surface of water within a tree stand. The float (110) is constructed of a buoyant material that rests on or near the surface of the water. The float (110) may also be constructed of a non-buoyant material, but have a hollow interior to achieve a buoyant characteristic. Some embodiments of the present invention may use a cork or a hollow rubber ball as the float (110). Yet other embodiments of the present invention may use a small piece of wood, plastic or Styrofoam as the float (110).

The float (110) has sufficient buoyancy to support a shaft (102) that is connected to the float (110). Sufficient buoyancy is considered to be enough buoyancy so that the float (110) and shaft (102) do not sink into the water thereby causing water level in the tree stand to be mis-indicated. Mis-indication occurs when a user is led to believe the water level in the tree stand is significantly lower or higher than it actually is.

The shaft (102) is a relatively elongated member that extends from the float (110), which resides on the surface of the water in a tree stand, to outside of the tree stand. Some embodiments of the present invention provide a shaft (102) that is a cylinder or tube. Other embodiments of the present invention provide a shaft (102) that is an elongated rectangle. At least a portion of the shaft (102) is visible to a user when the present invention is in use.

The shaft (102) has one or more indicator markings (101) that indicate to a user the level of water in the tree stand. Changes in the vertical position of the shaft (102) and markings (101) can be used to track the corresponding change in the water level within the tree stand. As a tree in the tree stand absorbs water, the water level drops and the shaft (102) moves downwards toward the bottom of the tree stand. A user will observe that the markings (101) have also moved downward indicating the drop in the water level. When the user replenishes the water level, the float (110) causes the shaft (102) to rise, and the markings (101) also rise. The rise of the shaft (102) and markings (101) indicate to the user that the water level has risen.

Some embodiments of the present invention provides a shaft (102) with an end marker (100) that clearly marks the end of the shaft (102). The end marker (100) can be used in conjunction with the markings (101) or may be used instead of the markings (101). In embodiments that provide the end marker (100), the end marker (100) can be visually distinguishable from the markings (101) so that a user can clearly and easily differentiate between the end marker (100) and the markings (101) along the shaft (102). Some embodiments of the present invention provide an end marker (100) that is a different color from the markings (101). Other embodiments of the present invention provide an end marker (100) that is larger or bolder than the markings (101).

The shaft (102) passes through a transparent or semi-transparent housing (107). The housing (107) keeps the shaft (102) upright while allowing for vertical movement of the shaft (102). The housing (107) has a large enough inner diameter so that the shaft (102) is not prevented from moving up or down relative to the changes in the water level within the tree stand.

The housing (107) is typically constructed from a clear or semi-clear material such as plastic or glass that allows the markings (101) on the shaft (102) to be visible from within the housing (107). As the water level in the tree stand raises or lowers, the shaft (102) correspondingly moves up or down within the housing (107) and a user can use the markings (101) to more easily track the changes in the water level. The markings (101) are still visible as they travel through the housing (107).

In embodiments that provide the end marker (100), the end marker (100) can be used not only to determine the level of water within the tree stand, but also to indicate whether the shaft (102) is about to pass through the bottom and out of the housing (107). Thus, the end marker (100) can be used to prevent malfunctions of the present invention by queuing a user to add more water to the tree stand or reposition the water level gauge.

An indicator line (104) may be provided on the housing (107) with some embodiments of the present invention for enhancing the tracking of changes in the water level. The positions of the markings (101) can be compared to the indicator line (104) to determine the distance between the two (101, 104). Changes in the distance between the markings (101) and the indicator line (104) correspond to changes in the water level within the tree stand. It is important to note that some embodiments of the present invention may be provided that do not possess an indicator line (104) on the housing (107). Yet other embodiments of the present invention may provide a plurality of indicator lines (104) at different positions on the housing (107). One embodiment of the present invention provides an indicator line (104) near the top of the housing (107) and a second indicator line (104) near the mid-point of the housing (107).

Embodiments of the present invention can be secured to many different shapes, makes, and models of tree stands. Embodiments of the present invention comprise components that allow for attachment to tree stands that hold a tree and contain water for that tree. An attachment device is a component of the present invention that comprises a housing clamp (105) and an attachment body (106). The housing clamp (105) detachably attaches to the housing (107) of the present invention. The housing (107) is held in place by friction generated from the clamping pressure of the clamp (105). This allows the housing (104) and the clamp (105) to be easily separated by a user. The housing clamp (105) clamps the housing (107) and prevents unwanted movement of the housing (107) or the shaft (102). The housing clamp (105) allows a user to remove the housing (107) from the clamp (105). A user can also adjust the position of the housing (107) within the clamp (105). This is particularly useful when a user wishes to raise or lower the housing (107) within the clamp (105) for such purposes as calibrating the markings (101) with the indicator line (104) or adjusting the present invention during installation.

The clamp (105) is attached to an attachment body (106). The attachment body (106) is, in turn, secured to a tree tree stand by an adhesive (111). The adhesive (111) can be glue, double-sided tape, an adhesive pad or the like. In embodiments using double-sided tape or an adhesive pad, one side of the tape or pad is adhered to the underside of the attachment body (106) while the other side of the tape or pad is readily adherable to a tree stand. In some embodiments of the present invention, the tape or pad is adhered to the lip of a tree stand and positioned so that the float (110) and shaft (102) can extend down into the water. The attachment body (106) extends the clamp (105) out over the opening of the tree stand so that it is in position over the water within the tree stand so that the shaft (102) and float (110) can extend down from the housing (107) to the water within the tree stand. Horizontal adjustment of the present invention is possible by moving the attachment body (106) laterally over an edge of the tree stand before securing the attachment body (106) to the tree stand. This horizontal adjustment allows a user to position embodiments of the present invention as necessary to avoid interference from tree branches or to align the invention as the user sees fit.

While some embodiments of the present invention may use adhesive (111) to attach the present invention to a tree stand, other embodiments of the present invention can use a mechanical fastener such as a clamp or clip to detachably attach the water (109) level gauge to a tree stand. The mechanical fastener has a set of jaws that fit around the lip of a tree stand. The jaws are tightenable by way of a screw or bolt that the user rotates to increase gripping pressure. The mechanical fastener may also be a spring-type clip the grasps the opening of a tree stand because of the pressure exerted by a spring on a pair of jaws. The mechanical fastener allows users to secure the present invention to tree stands when using an adhesive is not practicable, such as when flat surface is not present on the tree stand.

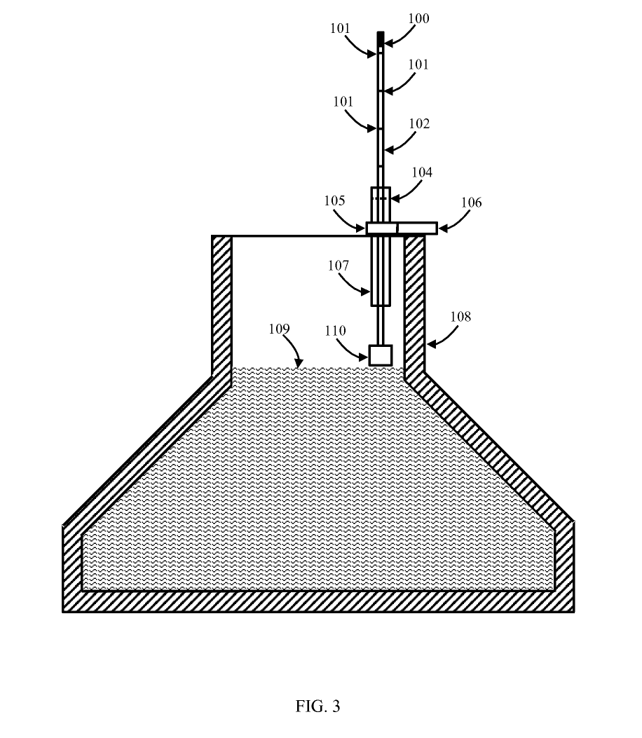

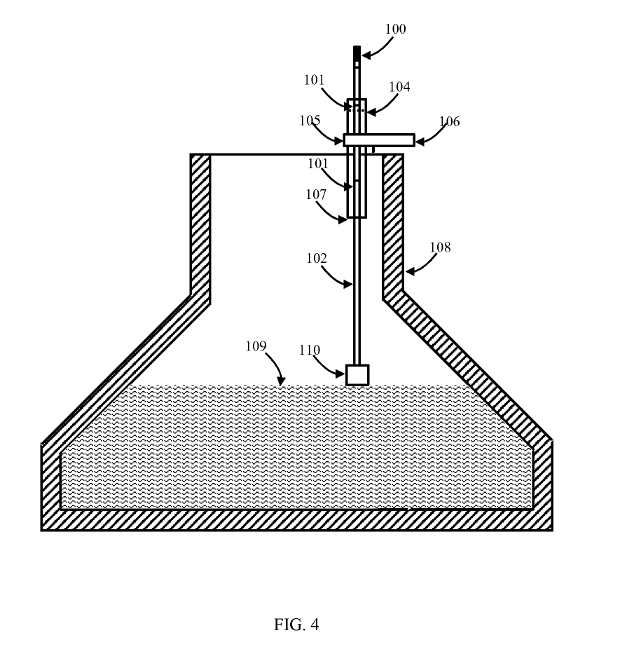

Referring now to FIGS. 3 and 4 that will be discussed together, there are shown views of a tree stand water (109) level gauge measuring high and low water (109) levels in a tree stand (108) as according to embodiments of the present invention. As shown in FIG. 3, when the water (109) level is high, the float (110) rests on the surface of the water (109) which is nearer to the top of the tree stand (108). When the water (109) is closer to the top of the tree stand, the shaft (102) extends up further through the housing (107). More of the markings (101) may be visible above or through the housing (107) than below the housing (107). As the tree absorbs the water (109), evaporation occurs, or water (109) is otherwise removed from the tree stand (108), the float (110) remains on the surface of the water (109) as the water (109) level drops. The float (110) and shaft (107) move downwards toward the bottom of the tree stand (108). The markings (101) on the shaft (102) also move downward indicating to a user that the water (109) level, which may not be visible to the user, is dropping within the stand (108).

When the water (109) drops significantly, as shown in FIG. 4, the float (110) and shaft (102) also lower in relationship to the water (109) level. More markings (101) on the shaft (102) may be visible within or below the housing (107) than above the housing (107). Of the lowering of the shaft (102), the end marker (100) and the markings (101) on the shaft (102), this embodiment of the present invention is indicating a lower water (109) level than that depicted in FIG. 3. The present invention allows a user to visually track the dropping water (109) level even if the water (109) level is not directly visible to the user. If the water (109) is replenished by the user or a watering system, the water (109) level will rise and the present invention will return to a state as depicted in FIG. 3.

There is described and illustrated a new and improved tree stand water (109) level gauge, generally denominated herein. The inventive portions of the water (109) level gauge include several components that, when taken together, constitute an embodiment of the present invention. The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and gauges for carrying out the several purposes of the present invention. It is important, therefore, that this description be regarded as including such equivalent constructions insofar as they do not depart from the spirit and scope of the present invention.

Although certain example methods, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Directional terms such as “front”, “forward”, “back”, “rear”, “in”, “out”, “downward”, “upper”, “lower”, “top”, “bottom”, “upper”, “lower” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a tree stand water level gauge. Further, since numerous modifications and changes will readily occur to those skilled in the art, it is not desired to limit the tree stand water level gauge to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

We claim:

1. An apparatus comprising:
a float that floats on the surface of water within a tree stand; an elongated shaft that is connected to the float, the shaft extending from the float to outside of the tree stand so that a portion of the shaft is visible to a user; a transparent or semi-transparent housing through which the shaft passes, the housing having a large enough inner diameter so that vertical movement of the shaft is not prevented; a housing clamp that clamps to the housing and holds the housing in place, the housing clamp being attached to the housing so that adjustment of the position of the housing is possible; an attachment body that attaches to the housing clamp, the attachment body allowing the housing clamp to be positioned over the interior of the tree stand so that the shaft and float can extend down from the housing to the surface of the water within the tree stand; and an adhesive that secures the attachment body to the tree stand.

2. The apparatus of claim 1 further comprising one or more indicator markings on the shaft that indicate to the user the level of the surface of the water within the tree stand.

3. The apparatus of claim 2 wherein changes in the vertical position of the indicator markings are used to track the corresponding changes in the level of the surface of water within the tree stand.

4. The apparatus of claim 2 wherein the indicator markings are visible from within the housing.

5. The apparatus of claim 1 further comprising and end marker that marks the end of the shaft.

6. The apparatus of claim 1 further comprising an indicator line on the housing.

7. The apparatus of claim 1 wherein the float and shaft raise or lower within the housing correspondingly to the raising or lowering of the surface of water within the tree stand.

8. An apparatus for measuring the level of water within a tree stand comprising:
a float that floats on the surface of water within a tree stand; an elongated shaft that is connected to the float; a transparent or semi-transparent housing through which the shaft passes, the housing having a large enough inner diameter so that vertical movement of the shaft is not prevented; a housing clamp that holds the housing in position while still allowing for adjustment of the position of the housing; an attachment body that attaches to the housing clamp, the attachment body allowing the housing clamp to be positioned over the interior of the tree stand so that the shaft and float can extend down from the housing to the surface of the water within the tree stand; an adhesive that secures the attachment body to a tree stand; wherein as the water level in the tree stand raises or lowers, the float correspondingly raises or lowers as it remains on the surface of the water thereby by causing the shaft to move up or down within the housing.

9. The apparatus of claim 8 wherein when the level of water within a tree stand is high, the float rests on the surface of the water closer to the top of the tree stand thereby causing more of the shaft to extend up through the housing and more of the shaft is visible above or through the housing than below the housing.

10. The apparatus of claim 8 wherein when the level of water within a tree stand is low, the float rests on the surface of the water closer to the bottom of the tree stand thereby causing less of the shaft to extend up through the housing and more of the shaft is visible below or through the housing than above the housing.

11. The apparatus of claim 8 wherein a portion of the shaft is visible to a user even if the surface of water within the tree stand is not visible to the user.

12. The apparatus of claim 8 wherein the attachment body can be horizontally adjusted so that interference from branches of a tree within the tree stand is avoided.

13. The apparatus of claim 8 wherein the adhesive is an adhesive pad that has one side adhered to the underside of the attachment body and the other side being able to be adhered to a tree stand.

14. The apparatus of claim 8 wherein the float is constructed of a buoyant material or is constructed with a hollow interior.

15. An apparatus for tracking the change in the level of water within a tree stand comprising:
a float that floats on the surface of water within a tree stand and causes an elongated shaft to rise or fall correspondingly to the rise or fall of the water level in the tree stand, the shaft being attached to the float; a transparent or semi-transparent housing through which the shaft passes, the transparency of the housing allowing indicator markings on the shaft to be visible through the housing, an indicator line on the housing allowing for more precise tracking of rise or fall of the water level within the tree stand, the housing keeping the shaft in a vertical position as it rises or falls; a housing clamp that holds the housing in position while still allowing for adjustment of the position of the housing; an attachment body that attaches to the housing clamp, the attachment body allowing the housing clamp to be positioned over the interior of the tree stand so that the shaft and float can extend down from the housing to the surface of the water within the tree stand; and a mechanical fastener that fastens the apparatus to the tree stand.

16. The apparatus of claim 15 wherein the float is constructed from a buoyant material or is constructed with a hollow design that provides buoyancy.

17. The apparatus of claim 16 wherein the float has sufficient buoyancy to support itself and the shaft on the surface of the water within the tree stand.

18. The apparatus of claim 15 wherein the housing has an inner diameter large enough to not prevent the vertical movement of the shaft as the level of the water in the tree stand rises or falls.

19. The apparatus of claim 15 wherein the mechanical fastener is a set of jaws that fit around the lip of a tree stand.

20. The apparatus of claim 19 wherein the jaws are tightenable by way of a screw or bolt that rotate to increase gripping pressure.
